(19) United States
(12) Patent Application Publication
(10) Pub. No.: US 2006/0164756 A1
(43) Pub. Date: Jul. 27, 2006

(54) Perpendicular magnetic recording head

(75) Inventors: Hiroshi Kameda, Niigata-ken (JP); Kiyoshi Kobayashi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/336,250

(22) Filed: Jan. 20, 2006

(30) Foreign Application Priority Data
Jan. 25, 2005 (JP) 2005-016732

(51) Int. Cl. G11B 5/127

(52) U.S. Cl. 360/125

(57) ABSTRACT

An auxiliary magnetic section has a multilayer structure consisting of auxiliary magnetic layers and a non-magnetic layer and a first auxiliary magnetic layer is bonded to a main magnetic pole layer. This allows the auxiliary magnetic layers to have large induced magnetic anisotropy due to antiferromagnetic coupling in a track width direction. Since the first auxiliary magnetic layer is ferromagnetically coupled with the main magnetic pole layer, the magnetization of the main magnetic pole layer can be more properly directed in the track width direction as compared to known main magnetic pole layers and has low remanence. This leads to an increase in magnetic recording efficiency.

### BACKGROUND OF THE INVENTION

1. Field of the Invention

The present invention relates to perpendicular magnetic recording heads for recording data by applying magnetic fields perpendicularly to faces of recording media such as discs. The present invention particularly relates to a thin-film magnetic head which includes a first magnetic layer (a main magnetic pole layer) having low remanence and which has high magnetic recording efficiency.

2. Description of the Related Art

A perpendicular magnetic recording head includes a main magnetic pole layer, a return path layer, and a coil layer and has a vertical cross section shown in, for example, FIG. 3a of Publication No. US 2004/0075927 A1 (hereinafter referred to as Patent Document 1). The main magnetic pole layer has a front end face, opposed to a recording medium, having an area sufficiently less than that of a front end face of the return path layer. Therefore, a leakage recording magnetic field is concentrated on the front end face of the main magnetic pole layer and the recording medium is magnetized due to the leakage recording magnetic field, whereby magnetic data is recorded on the recording medium.

The main magnetic pole layer has high saturation flux density but unsatisfactory soft magnetic properties such as magnetic permeability and coercive force. Therefore, the main magnetic pole layer has high remanence. The magnetic data recorded on the recording medium is erased due to the high remanence of the main magnetic pole layer in some cases. Publication No. US 2004/0120074 A1 (hereinafter referred to as Patent Document 2) and Publication No. US 2004/0004786 A1 (hereinafter referred to as Patent Document 3) indicate that the reduction of the remanence of the main magnetic pole layer is an issue. In order to solve the above problem, Patent Documents 2 and 3 disclose multilayer-type main magnetic pole layers having a multilayer structure including magnetic sub-layers and non-magnetic sub-layers.

Since each main magnetic pole layer has a multilayer structure including a plurality of magnetic sub-layers and non-magnetic sub-layers each disposed therebetween, a recording magnetic field applied from the main magnetic pole layer to a recording medium is distributed. Since the main magnetic pole layer includes a plurality of the magnetic sub-layers, a front end face of the main magnetic pole layer has an area greater than that of the front end face of that main magnetic pole layer having a single-layer structure. This leads to a reduction in magnetic flux density per unit area, resulting in a reduction in output.

### SUMMARY OF THE INVENTION

It is an object of the present invention to solve the above problems. The present invention provides a thin-film magnetic head having high magnetic recording efficiency. The thin-film magnetic head includes a first magnetic layer (a main magnetic pole layer) and an auxiliary magnetic section in contact therewith. The auxiliary magnetic section has an improved structure and the first magnetic layer therefore has low remanence.

A magnetic head according to the present invention includes a first magnetic layer having a face opposed to a recording medium; a second magnetic layer which has a face opposed to the recording medium and which is spaced from the first magnetic layer at a predetermined distance in a thickness direction, the opposed face of the second magnetic layer being longer than that of the first magnetic layer in a track width direction; and a magnetic field generator for applying a recording magnetic field to the first and second magnetic layers. An auxiliary magnetic section including a plurality of auxiliary magnetic layers and non-magnetic layers each disposed between the auxiliary magnetic layers is disposed on at least one of an inside face of the first magnetic layer that is directed to the second magnetic layer and an outside face of the first magnetic layer that is opposite to the inside face, the auxiliary magnetic layers are arranged in the thickness direction, and one of the auxiliary magnetic layers that is most close to the first magnetic layer is directly bonded to the first magnetic layer.

According to the present invention, the auxiliary magnetic section has a multilayer structure in which the auxiliary magnetic layers and the non-magnetic layer are stacked and one of the auxiliary magnetic layers that is most close to the first magnetic layer is directly bonded to the first magnetic layer. Therefore, the auxiliary magnetic layers have strong induced magnetic anisotropy due to antiferromagnetic coupling in the track width direction. Since the first auxiliary magnetic layer is ferromagnetically coupled with the main magnetic pole layer, the magnetization of the main magnetic pole layer can be more properly directed in the track width direction as compared to known main magnetic pole layers and has low remanence.

In the magnetic head, the auxiliary magnetic section preferably has a front end face which is directed to the opposed faces and which is spaced back from the opposed faces in the direction toward a rear end face of the first magnetic layer. Small magnetic domains magnetized in the direction (referred to as a height direction) from a front end face of the first magnetic layer to the rear end face thereof are likely to be present in both side end regions of front end faces of the auxiliary magnetic layers, the side end regions being spaced from each other in the track width direction. If the front end faces of the auxiliary magnetic layers are exposed from the opposed faces, data recorded on the recording medium is erased due to the remanence of the auxiliary magnetic layers in some cases. Therefore, the front end faces of the auxiliary magnetic layers are preferably spaced back from the opposed faces.

The magnetic head preferably further includes an antiferromagnetic layer bonded to a face of the auxiliary magnetic section that is opposite to a joint face of the auxiliary magnetic section that is bonded to one of the non-magnetic layers that is most distant from the first magnetic layer. This allows magnetic domains of the auxiliary magnetic layers to be stabilized. Therefore, magnetic domains of the main magnetic pole layer are also stabilized.

In the magnetic head, it is preferable that the first magnetic layer have side end faces directed in the track width direction, the auxiliary magnetic section have side end faces directed in the track width direction, and the side end faces of the first magnetic layer be located between those of the auxiliary magnetic section or be each flush with the corresponding side end faces of the auxiliary magnetic section in the thickness direction. A rear end face of the first magnetic layer is preferably more close to the opposed faces than a rear end face of the auxiliary magnetic section or is preferably flush with the rear end face of the auxiliary magnetic section in the thickness direction. This allows the magnetization of the main magnetic pole layer to be directed in the track width direction. Therefore, the main magnetic pole layer has low remanence. This leads to an increase in magnetic recording efficiency.

According to the present invention, the auxiliary magnetic section has a multilayer structure consisting of the auxiliary magnetic layers and the non-magnetic layer and one of the auxiliary magnetic layers that is most close to the first magnetic layer is directly bonded to the first magnetic layer. This allows the auxiliary magnetic layers to have large induced magnetic anisotropy due to antiferromagnetic coupling in a track width direction. Since the first auxiliary magnetic layer is ferromagnetically coupled with the main magnetic pole layer, the magnetization of the main magnetic pole layer can be more properly directed in the track width direction as compared to known main magnetic pole layers and has low remanence. This leads to an increase in magnetic recording efficiency.

The main magnetic pole layer, unlike the main magnetic pole layers disclosed in the patent documents cited above, has a single-layer structure. Therefore, the main magnetic pole layer can apply a strong leakage magnetic field (a large magnetic flux density per unit area) to the recording medium. This leads to an increase in output.

### BRIEF DESCRIPTION OF THE DRAWINGS

FIG. 1 is a fragmentary vertical sectional view of a perpendicular magnetic recording head according to an embodiment of the present invention;

FIG. 2 is a vertical enlarged sectional view of a portion of FIG. 1, the portion including a main magnetic pole layer, a return path layer, and an auxiliary magnetic section;

FIG. 3 is a fragmentary plan view of the perpendicular magnetic recording head shown in FIG. 1;

FIG. 4 is a schematic view, perpendicular to the plane of FIG. 2, illustrating the magnetic domain structure of the auxiliary magnetic section (an auxiliary magnetic layer);

FIG. 5 is a schematic view, perpendicular to the plane of FIG. 2, illustrating the magnetic domain structure of the main magnetic pole layer;

FIG. 6 is a schematic view, perpendicular to the plane of FIG. 2, illustrating the magnetic domain structure of a main magnetic pole layer including no auxiliary magnetic section, the main magnetic pole layer being included in a perpendicular magnetic recording head according to another embodiment of the present invention;

FIG. 7 is a fragmentary plan view of a perpendicular magnetic recording head according to another embodiment of the present invention;

FIG. 8 is a fragmentary vertical sectional view of a perpendicular magnetic recording head according to another embodiment of the present invention;

FIG. 9 is a fragmentary vertical sectional view of a perpendicular magnetic recording head according to another embodiment of the present invention;

FIG. 10 is a fragmentary vertical sectional view of a perpendicular magnetic recording head according to another embodiment of the present invention;

FIG. 11 is a fragmentary plan view of the perpendicular magnetic recording head shown in FIG. 10; and

FIG. 12 is a fragmentary bottom view of a perpendicular magnetic recording head according to another embodiment of the present invention.

### DESCRIPTION OF THE PREFERRED EMBODIMENTS

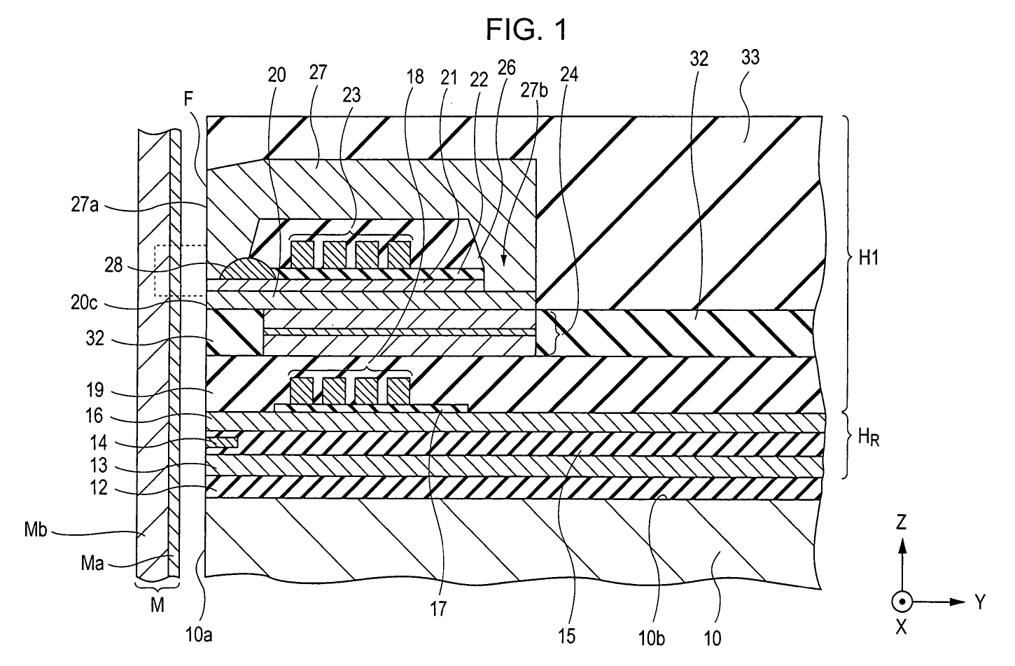

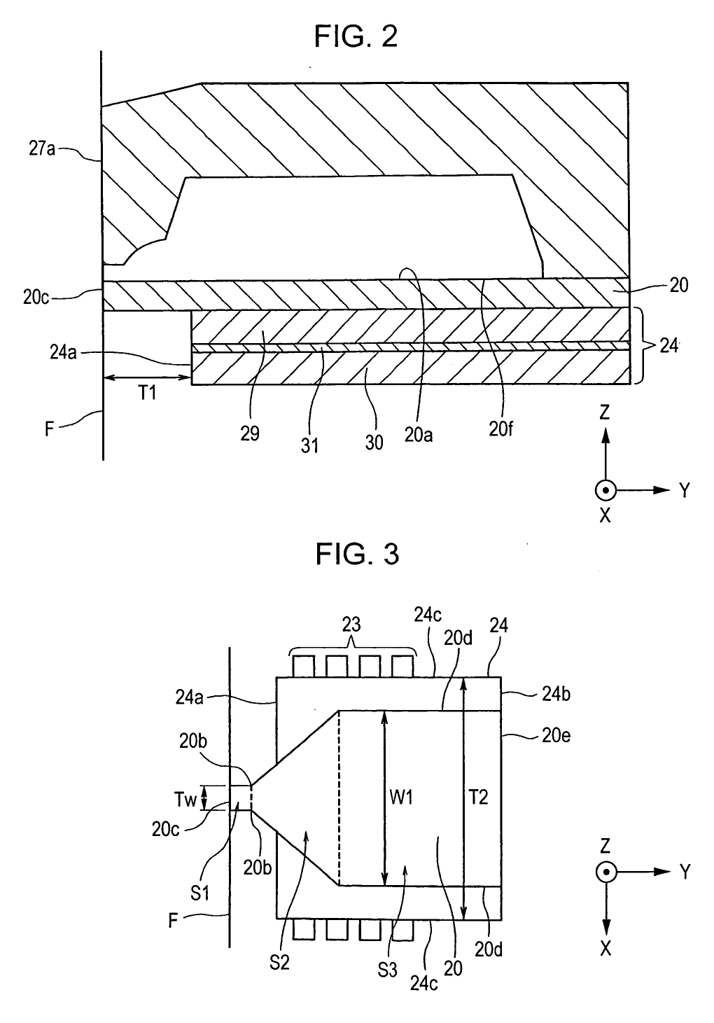

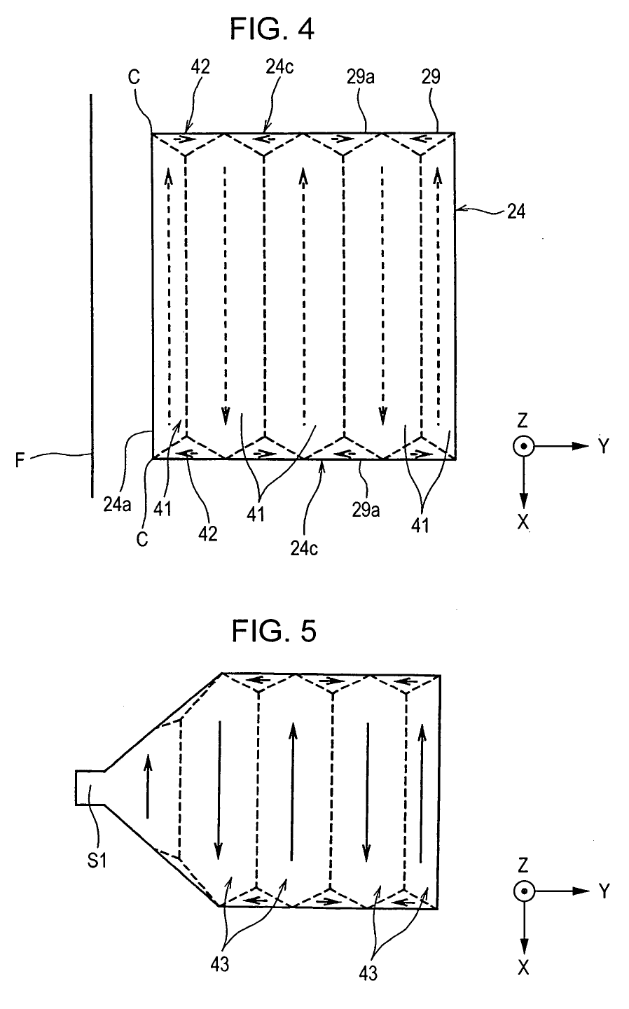

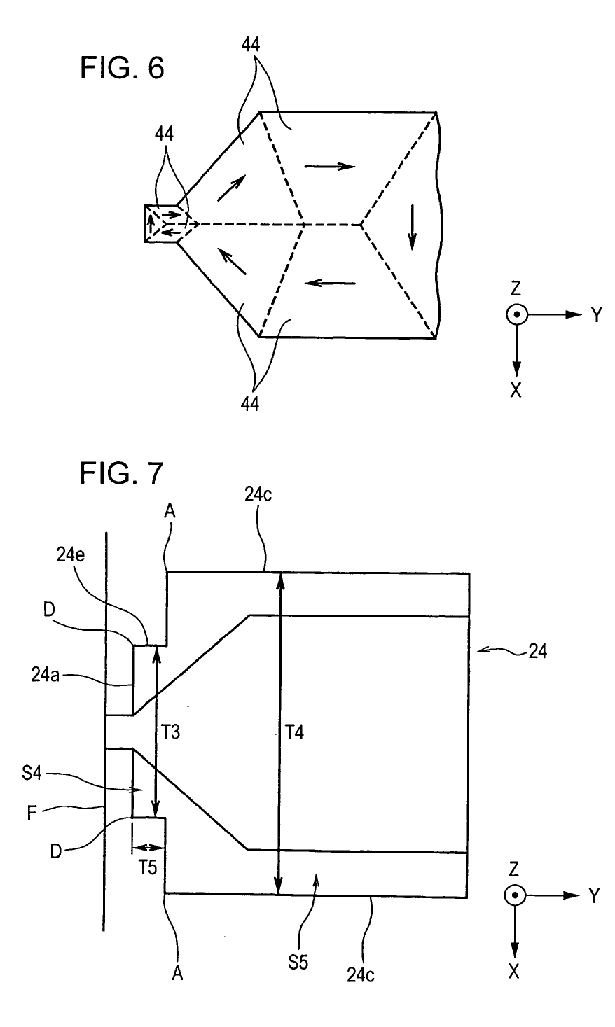

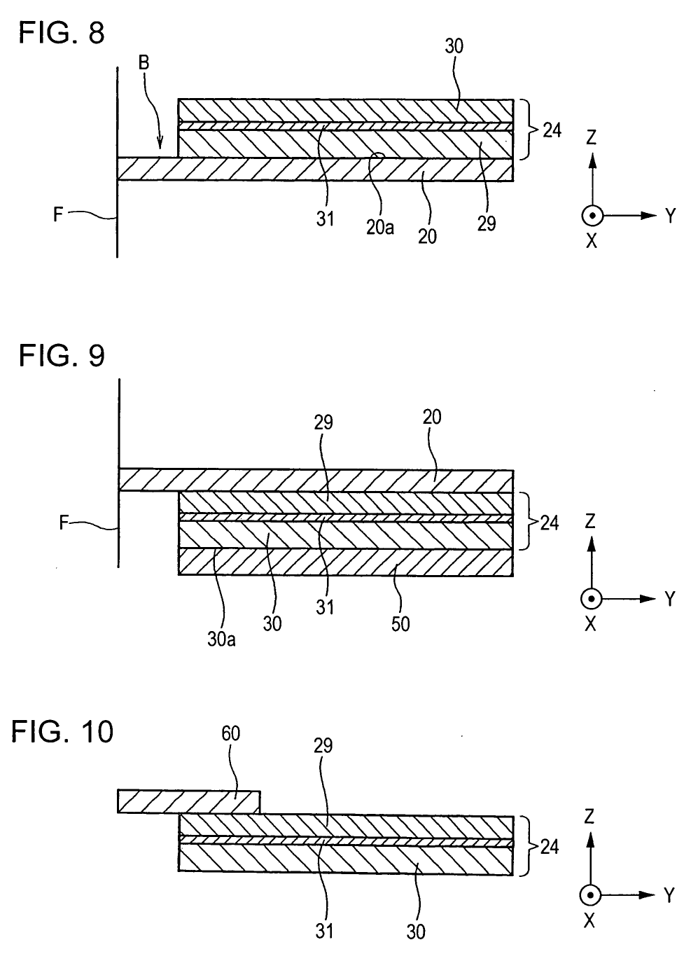

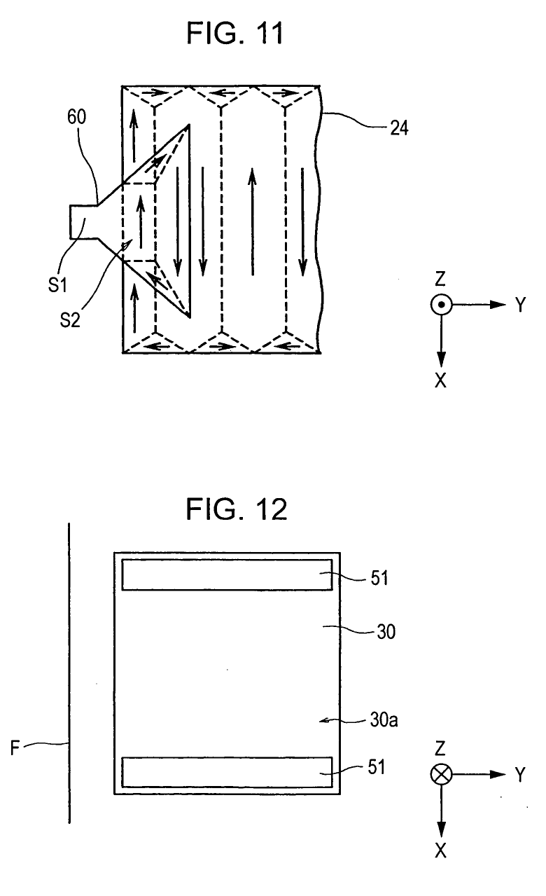

FIG. 1 is a fragmentary vertical sectional view of a perpendicular magnetic recording head according to an embodiment of the present invention. FIG. 2 is a vertical enlarged sectional view of a portion of FIG. 1, the portion including a main magnetic pole layer, a return path layer, and an auxiliary magnetic section. FIG. 3 is a fragmentary plan view of the perpendicular magnetic recording head shown in FIG. 1. FIG. 4 is a schematic view, perpendicular to the plane of FIG. 2, illustrating the magnetic domain structure of the auxiliary magnetic section (an auxiliary magnetic layer). FIG. 5 is a schematic view, perpendicular to the plane of FIG. 2, illustrating the magnetic domain structure of the main magnetic pole layer. FIG. 6 is a schematic view, perpendicular to the plane of FIG. 2, illustrating the magnetic domain structure of a main magnetic pole layer including no auxiliary magnetic section, the main magnetic pole layer being included in a perpendicular magnetic recording head according to another embodiment of the present invention. FIG. 7 is a fragmentary plan view of a perpendicular magnetic recording head according to another embodiment of the present invention. FIGS. 8 to 10 are fragmentary vertical sectional views of perpendicular magnetic recording heads according to other embodiments of the present invention. FIG. 11 is a fragmentary plan view of the perpendicular magnetic recording head shown in FIG. 10. FIG. 12 is a fragmentary bottom view of a perpendicular magnetic recording head according to another embodiment of the present invention.

In descriptions below, the X direction in these figures is referred to as a track width direction, the Y direction is referred to as a height direction, and the Z direction is referred to as a thickness direction. The track width direction is perpendicular to both the height direction and the thickness direction. The height direction may be referred to as an element height direction, which is perpendicular to a face F (hereinafter simply referred to as an opposed face F) opposed to a recording medium and away from the opposed face F.

As shown in FIG. 1, the perpendicular magnetic recording head represented by reference numeral Hi applies a perpendicular magnetic field to the recording medium represented by reference numeral M, whereby a hard layer Ma included in the recording medium M is perpendicularly magnetized.

The recording medium M has, for example, a disc shape, further includes a soft layer Mb, and rotates on its center axis. The hard layer Ma is located far from the perpendicular magnetic recording head H1 and has high remanence. The soft layer Mb is located close to the perpendicular magnetic recording head H1 and has high magnetic permeability.

A slider 10 is made of a non-magnetic material such as Al₂O₃—TiC and has an opposed face 10a opposed to the recording medium M. The rotation of the recording medium M creates an air flow, which separates the recording medium M from the slider 10 or allows the slider 10 to slide above the recording medium M.

The slider 10 has a trailing face (upper face) 10b. A non-magnetic insulating layer 12 made of an inorganic material such as Al₂O₃ or SiO₂ lies on the trailing face 10b. A reading section H_{R} lies on the non-magnetic insulating layer 12.

The reading section H_{R} includes a lower shield layer 13, a reading element 14, an inorganic insulating layer (gap insulating layer) 15, and an upper shield layer 16. The inorganic insulating layer 15 lies between the lower shield layer 13 and the upper shield layer 16. The reading element 14 is located in the inorganic insulating layer 15 and is a type of magnetoresistive sensor such as an AMR, a GMR, or a TMR.

A first coil-insulating base layer 17 lies on the upper shield layer 16 and a plurality of lower coil pieces 18 made of a conductive material are arranged on the first coil-insulating base layer 17. In particular, the lower coil pieces 18 are made of one or more non-magnetic metal materials selected from the group consisting of Au, Ag, Pt, Cu, Cr, Al, Ti, NiP, Mo, Pd, and Rh. Alternatively, the lower coil pieces 18 may each include stacked layers made of one or more of the non-magnetic metal materials.

The lower coil pieces 18 are covered with a first coil-insulating layer 19 made of an inorganic material such as Al₂O₃ or an organic material such as a resist.

The upper face of the first coil-insulating layer 19 is flat and has a plating base layer (not shown) disposed thereon. An auxiliary magnetic section 24 is disposed on the plating base layer.

With reference to FIG. 2, the auxiliary magnetic section 24 includes a first auxiliary magnetic layer 29, a non-magnetic layer 31, and a second auxiliary magnetic layer 30, these layers being arranged in that order in the thickness direction (Z direction). With reference to FIG. 1, the auxiliary magnetic section 24 is surrounded by an insulating material layer 32 made of Al₂O₃, SiO₂, or another insulating material. The upper face of the auxiliary magnetic section 24 and that of the insulating material layer 32 are planarized such that the upper faces thereof are flush with each other. With reference back to FIG. 2, the auxiliary magnetic section 24 has a front end face 24a directed to the opposed face F. The front end face 24a is spaced back from the opposed face F at a distance T1 in the height direction (Y direction).

With reference to FIGS. 1 and 2, a main magnetic pole layer 20 lies over the auxiliary magnetic section 24 and a portion of the insulating material layer 32 that is located between the opposed face F and the front end face 24a of the auxiliary magnetic section 24. The main magnetic pole layer 20 extends from the opposed face F in the height direction (Y direction) and has a predetermined length. With reference to FIG. 3, the main magnetic pole layer 20 has a front end face 20c, which extends in the track width direction (X direction). The width of the front end face 20c is referred to as a track width Tw.

The main magnetic pole layer 20 can be formed by a plating process and is made of a material, such as Ni—Fe, Co—Fe, or Ni—Fe—Co, having high magnetic flux density.

With reference to FIG. 3, the main magnetic pole layer 20 includes a front section S1 having a proximal end 20b, a slope section S2, and a rear section S3 having side end faces 20d parallel to the height direction. The slope section S2 expands from the proximal end 20b to the rear section S3 in the height direction (Y direction) and has an end portion which is in contact with the rear section S3 and which has a width greater than the track width Tw. For the sake of clarity in FIG. 3, the front section S1, the slope section S2, and the rear section S3 are partitioned from each other with dotted lines. In particular, the track width Tw is 0.01 to 0.5 μm and the front section S1 has a length of 0.01 to 0.5 μm in the height direction. The rear section S3 has a width W1 of 1 to 100 μm in the track width direction (X direction). The slope section S2 and the rear section S3 both have a length of 1 to 100 μm in the height direction.

With reference to FIG. 1, a gap layer 21 made of an inorganic material such as Al₂O₃ or SiO₂ lies on the main magnetic pole layer 20.

A second coil-insulating base layer 22 lies on the gap layer 21 and a plurality of upper coil pieces 23 are arranged on the second coil-insulating base layer 22 as shown in FIG. 1. The upper coil pieces 23 as well as the lower coil pieces 18 are made of a conductive material. In particular, the upper coil pieces 23 are made of one or more non-magnetic metal materials selected from the group consisting of Au, Ag, Pt, Cu, Cr, Al, Ti, NiP, Mo, Pd, and Rh. Alternatively, the upper coil pieces 23 may each include stacked layers made of one or more of the non-magnetic metal materials.

End portions of the lower coil pieces 18 are electrically connected to end portions of the upper coil pieces 23 such that toroidal coils are formed, the end portions being disposed in the track width direction (X direction).

The upper coil pieces 23 are covered with a second coil-insulating layer 26 made of an inorganic material such as Al₂O₃ or an organic material such as a resist. A return path layer 27 made of a ferroelectric material such as permalloy lies over the second coil-insulating layer 26 and the gap layer 21. The return path layer 27 has a connecting section 27b which is disposed on the rear side thereof in the height direction and which is magnetically connected to the main magnetic pole layer 20. A Gd decision layer 28 made of an inorganic or organic material is located at a position which is present on the gap layer 21 and which is spaced from the opposed face F at a predetermined distance. The distance between the opposed face F and the front end of the Gd decision layer 28 corresponds to the gap depth of the perpendicular magnetic recording head H1.

The return path layer 27 is covered with a protective layer 33 made of an inorganic non-magnetic insulating material as shown in FIG. 1.

The return path layer 27 has a front end face 27a. The front end face 20c of the main magnetic pole layer 20 has a height less than that of the front end face 27a of the return path layer 27 and a width Tw sufficiently less than that of the front end face 27a of the return path layer 27 in the track width direction (X direction). That is, in the opposed face F, the front end face 20c of the main magnetic pole layer 20 has an area sufficiently less than that of the front end face 27a of the return path layer 27. Therefore, the magnetic flux φ of a leakage recording magnetic field is concentrated on the front end face 20c of the main magnetic pole layer 20. The hard layer Ma is perpendicularly magnetized due to the magnetic flux φ, whereby magnetic data is recorded on the recording medium M.

Features of the perpendicular magnetic recording head H1 will now be described. With reference to FIG. 1, in the opposed face F, the main magnetic pole layer (first magnetic layer) 20 and the return path layer (second magnetic layer) 27 are opposed to each other with the gap layer 21 disposed therebetween, that is, the main magnetic pole layer 20 and the return path layer 27 are spaced from each other in the thickness direction (Z direction) with a predetermined distance.

With respect to FIG. 2, the upper face 20a of the main magnetic pole layer 20 is an inside face directed to the return path layer 27. The upper coil pieces 23 are arranged in a gap between the upper face 20a of the main magnetic pole layer 20 and the lower face (an inside face directed to the main magnetic pole layer 20) of the return path layer 27. The upper coil pieces 23 are components of a toroidal coil layer for generating a magnetic field.

The auxiliary magnetic section 24 is disposed under the lower face 20f (an outside face opposite to the inside face) of the main magnetic pole layer 20. The auxiliary magnetic section 24 has a multilayer structure in which the first auxiliary magnetic layer 29, the non-magnetic layer 31, and the second auxiliary magnetic layer 30 are arranged in that order in the thickness direction (Z direction).

The first and second auxiliary magnetic layers 29 and 30 are made of a magnetic material having soft magnetic properties better than those of the main magnetic pole layer 20, that is, a magnetic material having a magnetic permeability greater than that of the main magnetic pole layer 20 and a coercive force less than that thereof. The non-magnetic layer 31 is made of alloy containing at least one selected from the group consisting of Ru, Rh, Ir, Cr, Re, and Cu. The first and second auxiliary magnetic layers 29 and 30 have a thickness of 0.01 to 10 μm and the non-magnetic layer 31 has a thickness of 6 to 8 Å. Since the first auxiliary magnetic layer 29 is antiferromagnetically coupled with the second auxiliary magnetic layer 30 with the non-magnetic layer 31 disposed therebetween, the magnetization of the first auxiliary magnetic layer 29 is antiparallel to that of the second auxiliary magnetic layer 30. The first and second auxiliary magnetic layers 29 and 30 can be formed by a sputtering process or another process in a magnetic field and may be then annealed in the magnetic field as required. Since the magnetic field is parallel to the track width direction (X direction), the first and second auxiliary magnetic layers 29 and 30 have high induced magnetic anisotropy in the track width direction (X direction) because of the antiferromagnetic coupling. That is, the first auxiliary magnetic layer 29 included in the auxiliary magnetic section 24 has a magnetic domain structure shown in FIG. 4 and the second auxiliary magnetic layer 30 has magnetic domains of which the magnetization directions are antiparallel to those of the auxiliary magnetic section 24.

With reference to FIG. 4, the first auxiliary magnetic layer 29 has first magnetic domains 41 of which the magnetization directions are along the track width direction (X direction). The first magnetic domains 41 occupy much of the first auxiliary magnetic layer 29. The first auxiliary magnetic layer 29 also has second magnetic domains 42 located at both side ends 29a thereof in the track width direction (X direction). The magnetization directions of the second magnetic domains 42 are along the height direction (Y direction). The second magnetic domains 42 are significantly smaller than the first magnetic domains 41. The magnetic domain structure of the second auxiliary magnetic layer 30 is the same as that of the first auxiliary magnetic layer 29. Since the non-magnetic layer 31 is disposed between the first and second auxiliary magnetic layers 29 and 30, the magnetic domain structures of the first and second auxiliary magnetic layers 29 and 30 are very stable due to the antiferromagnetic coupling.

With reference to FIGS. 1 and 2, the main magnetic pole layer 20 is directly bonded to the first auxiliary magnetic layer 29 included in the auxiliary magnetic section 24. That is, no non-magnetic material is present between the main magnetic pole layer 20 and the first auxiliary magnetic layer 29. This allows the main magnetic pole layer 20 and the first auxiliary magnetic layer 29 to be ferromagnetically coupled with each other. Therefore, as shown in FIG. 5, the main magnetic pole layer 20 has third magnetic domains 43, occupying much of the main magnetic pole layer 20, magnetized in the track width direction (X direction) and the front section S1 of the main magnetic pole layer 20 is magnetized in the track width direction (X direction). This allows the front section S1 of the main magnetic pole layer 20 to have low remanence parallel to the height direction (Y direction). Hence, recoded data can be prevented from being erased due to the remanence. This leads to an increase in magnetic recording efficiency.

Since the main magnetic pole layer 20, unlike those disclosed in the patent documents cited above, has a single-layer structure, the main magnetic pole layer 20 can apply a strong leakage magnetic field (a large magnetic flux density per unit area) to the recording medium M. This leads to an increase in output.

If the perpendicular magnetic recording head H1 does not the auxiliary magnetic section 24 for magnetization control, the main magnetic pole layer 20 has fourth magnetic domains 44 which occupy much of the main magnetic pole layer 20 and of which the magnetization directions are not along the height direction (Y direction) as shown in FIG. 6; hence, the front section S1 of the main magnetic pole layer 20 has high remanence parallel to the height direction (Y direction). However, the perpendicular magnetic recording head H1 includes the auxiliary magnetic section 24 such that the front section S1 thereof has low remanence; hence, the magnetic domains of the auxiliary magnetic section 24 and those of the main magnetic pole layer 20 can be properly controlled.

The auxiliary magnetic section 24 has a three-layer structure consisting of the first auxiliary magnetic layer 29, the non-magnetic layer 31, and the second auxiliary magnetic layer 30 and may have a multilayer structure including three or more auxiliary magnetic layers and non-magnetic layers each disposed therebetween. The first and second auxiliary magnetic layers 29 and 30 may have a multilayer structure including magnetic sub-layers.

With reference to FIGS. 1 to 5, the front end face 24a of the auxiliary magnetic section 24 is spaced back from the opposed face F in the height direction (Y direction), that is, in the direction toward the rear end face 20e of the main magnetic pole layer 20. The distance T1 between the opposed face F and the front end face 24a of the auxiliary magnetic section 24 is preferably 0.01 to 10 μm. With respect to FIG. 4, the second magnetic domains 42 which are small and which are magnetized in the height direction (Y direction) are arranged at both side end faces 24c of the auxiliary magnetic section 24. If the front end face 24a of the auxiliary magnetic section 24 is exposed at the opposed face F, remanent magnetic fields leaking from first corner regions C that are arranged in the front end face 24a of the auxiliary magnetic section 24 in the track width direction (X direction) are applied to the recording medium M, whereby data recorded on the recording medium M is erased. In order to prevent this problem, the front end face 24a of the auxiliary magnetic section 24 is spaced back from the opposed face F as described above.

With reference to FIGS. 3 and 4, the auxiliary magnetic section 24 has substantially a quadrilateral shape in plan view as shown in FIG. 3 or 4. In the track width direction (X direction), the maximum width T2 of the auxiliary magnetic section 24 is greater than the width (maximum width) W1 of the main magnetic pole layer 20 as shown in FIGS. 3 and 4. Although the maximum width T2 of the auxiliary magnetic section 24 may be substantially the same as the width W1 of the main magnetic pole layer 20, the maximum width T2 of the auxiliary magnetic section 24 is preferably greater than the width W1 of the main magnetic pole layer 20 as shown in FIG. 3. The small second magnetic domains 42 magnetized in the height direction (Y direction) are arranged at the side end faces 24c of the auxiliary magnetic section 24 as shown in FIG. 4. Since the each second magnetic domain 42 and the main magnetic pole layer 20 are arranged in the thickness direction and bonded to each other, magnetic domains magnetized in the height direction (Y direction) are likely to be arranged at the side end faces 20d of the main magnetic pole layer 20. The main magnetic pole layer 20 preferably has no magnetic domains magnetized in the height direction (Y direction). Therefore, the side end faces 24c of the auxiliary magnetic section 24 are preferably located outside the side end faces 20d of the main magnetic pole layer 20 in the track width direction (X direction) in such a manner that the auxiliary magnetic section 24 is formed so as to have a maximum width T2 greater than the width W1 of the main magnetic pole layer 20. This prevents the main magnetic pole layer 20 from suffering from the magnetic domains which are magnetized in the height direction (Y direction) and which are arranged at the side end faces 20d of the main magnetic pole layer 20.

It is preferable that the rear end face 24b of the auxiliary magnetic section 24 be flush with the rear end face 20e of the main magnetic pole layer 20 or be spaced therefrom in the height direction (Y direction). It is preferable that the side end faces 20d of the main magnetic pole layer 20, except a portion of the main magnetic pole layer 20 that is located between the opposed face F and the front end face 24a of the auxiliary magnetic section 24, be preferably located between the side end faces 24c of the auxiliary magnetic section 24 in the track width direction (X direction) as shown in FIG. 3 or the side end faces 20d of the main magnetic pole layer 20 and the side end faces 24c of the auxiliary magnetic section 24 be flush with each other in the thickness direction (Z direction). Furthermore, it is preferable the rear end face 20e of the main magnetic pole layer 20 be located more close to the opposed face F than the rear end face 24b of the auxiliary magnetic section 24 or the rear end face 20e of the main magnetic pole layer 20 and the rear end face 24b of the auxiliary magnetic section 24 be flush with each other in the thickness direction (Z direction). This allows the auxiliary magnetic section 24 and the lower face 20f of the main magnetic pole layer 20, except the portion of the main magnetic pole layer 20 that is located between the opposed face F and the front end face 24a of the auxiliary magnetic section 24, to be ferromagnetically coupled with each other. Therefore, the magnetic domains of the main magnetic pole layer 20 can be controlled properly and the front section S1 of the main magnetic pole layer 20 can be reduced in remanence.

The auxiliary magnetic section 24 has substantially a rectangular shape in plan view as shown in FIG. 2 or 3; however, the shape of the auxiliary magnetic section 24 is not limited to such a rectangular shape. A perpendicular magnetic recording head according to another embodiment of the present invention may include an auxiliary magnetic section 24 having a shape shown in FIG. 7. That is, this auxiliary magnetic section 24 may have a front section S4 and a rear section S5. The width T3 of the front section S4 is less than the width T4 of the rear section S5 in the track width direction (X direction). With reference to FIG. 7, the front section S4 has a length represented by T5 and extends from the rear section S5 toward the opposed face F. It is not preferable that the length T5 of the front section S4 be large, because an increase in the length T5 of the front section S4 leads to the formation of large magnetic domains magnetized in the height direction (Y direction). The length T5 of the front section S4 is preferably 0.01 to 10 μm. In this auxiliary magnetic section 24 shown in FIG. 7, if the distance between the opposed face F and the front end face 24a of the front section S4 is equal to the distance T1 shown in FIG. 2, second corner regions A present in both side end faces 24c of rear section S5 are spaced from the opposed face F in the height direction (Y direction), the second corner regions A being located close to the opposed face F. The side end faces 24c of rear section S5 are long in the height direction (Y direction), that is, the side end faces 24c of rear section S5 have a length greater than the length T5 of the front section S4. Therefore, magnetic domains which are magnetized in the height direction (Y direction) and which are arranged in the second corner regions A are larger than those arranged at third corner regions D present in both side end faces 24e of the front section S4, the third corner regions D being located close to the opposed face F. Therefore, recorded data can be prevented from being erased due to the remanence of the second corner regions A in such a manner that the second corner regions A are spaced from the opposed face F at a proper distance in the height direction (Y direction). This auxiliary magnetic section 24 having the shape shown in FIG. 7 is more preferable in preventing recorded data from being erased due to the remanence of this auxiliary magnetic section 24 as compared to that auxiliary magnetic section 24 having the rectangular shape shown in FIG. 4.

The first corner regions C of the auxiliary magnetic section 24 shown in FIGS. 3 and 4 and the second and third corner regions C and D of this auxiliary magnetic section 24 shown in FIG. 7 are preferably curved, the first, second, and third corner regions C, A, and D being located close to the opposed face F. This is because the first, second, and third corner regions C, A, and D have low remanence.

FIG. 8 shows a perpendicular magnetic recording head according to another embodiment of the present invention. This perpendicular magnetic recording head has a configuration similar to that of the perpendicular magnetic recording head H1 shown in FIG. 1 except components below. In this perpendicular magnetic recording head, an auxiliary magnetic section 24 is disposed on the upper face 20a of a main magnetic pole layer 20. Upper coil pieces 23, a return path layer 27, and other components are arranged on a second auxiliary magnetic layer 30. With respect to FIG. 8, since the auxiliary magnetic section 24 is disposed on the upper face 20a of a main magnetic pole layer 20 that is directed to the return path layer 27, an end portion of a Gd decision layer 28, that of a gap layer 21, and that of the return path layer 27 must be arranged in a gap B between the main magnetic pole layer 20 and the auxiliary magnetic section 24.

Alternatively, this perpendicular magnetic recording head H1 may include auxiliary magnetic sections 24 each disposed on the upper face 20a of the main magnetic pole layer 20 and under the lower face 20f thereof.

FIG. 9 shows a perpendicular magnetic recording head according to another embodiment of the present invention. This perpendicular magnetic recording head includes a first auxiliary magnetic layer 29, a second auxiliary magnetic layer 30, an antiferromagnetic layer 50, a main magnetic pole layer 20, and a non-magnetic layer 31. The antiferromagnetic layer 50 lies under the lower face 30a of the second auxiliary magnetic layer 30, the lower face 30a being opposite a face of the second auxiliary magnetic layer 30 that is bonded to the non-magnetic layer 31 and being most distant from the main magnetic pole layer 20, unlike the lower face 30a of that second auxiliary magnetic layer 30 shown in FIG. 8.

The antiferromagnetic layer 50 is made of a Pt—Mn alloy, an X—Mn alloy, or a Pt—Mn—X′ alloy, wherein X represents one or more elements selected from the group consisting of Pd, Ir, Rh, Ru, Os, Ni, and Fe and X′ represents one or more elements selected from the group consisting of Pd, Ir, Rh, Ru, Au, Ag, Os, Cr, Ni, Ar, Ne, Xe, and Kr. The antiferromagnetic layer 50 is heat-treated in a magnetic field of which the direction is along the track width direction (X direction) such that an exchange coupling magnetic field is created between the antiferromagnetic layer 50 and the second auxiliary magnetic layer 30. The exchange coupling magnetic field stabilizes magnetic domains present in the second auxiliary magnetic layer 30 and also stabilizes magnetic domains present in the first auxiliary magnetic layer 29 together with antiferromagnetic coupling between the first and second auxiliary magnetic layers 29 and 30.

In the perpendicular magnetic recording head H1 shown in FIG. 1, the reading element 14 of the reading section H_{R} usually includes an antiferromagnetic layer 50. The reading element 14 is a type of spin valve thin-film element (GMR element) and has a four-layer structure consisting of the antiferromagnetic layer 50, a fixed magnetic layer, a non-magnetic conductive layer, and a free magnetic layer. In the reading element 14, the antiferromagnetic layer 50 is useful in fixing the magnetization direction of the fixed magnetic layer in the height direction (Y direction). The antiferromagnetic layer 50 and the fixed magnetic layer are heat-treated in a magnetic field of which the magnetization direction is along the height direction (Y direction), whereby an exchange coupling magnetic field is created between the antiferromagnetic layer 50 and the fixed magnetic layer. However, in a subsequent step of heat-treating the antiferromagnetic layer 50 and the second auxiliary magnetic layer 30 in a magnetic field, the magnetization direction of this magnetic field is along the track width direction (X direction) and is different from that of that magnetic field applied to the antiferromagnetic layer 50 and the fixed magnetic layer during heat-treating. If the heat treatment temperature of the antiferromagnetic layer 50 and the second auxiliary magnetic layer 30 is higher than the heat treatment temperature of the antiferromagnetic layer 50 and the fixed magnetic layer, an exchange coupling magnetic field along the track width direction (X direction) is created between the antiferromagnetic layer 50 and the fixed magnetic layer, whereby the magnetization direction of the fixed magnetic layer is shifted from the height direction (Y direction). Hence, the heat treatment temperature of the antiferromagnetic layer 50 and the second auxiliary magnetic layer 30 must be lower than the heat treatment temperature of the antiferromagnetic layer 50 and the fixed magnetic layer. The intensity of the magnetic field applied to the antiferromagnetic layer 50 and the second auxiliary magnetic layer 30 during heat-treating must be less than that of the exchange coupling magnetic field created between the antiferromagnetic layer 50 and the fixed magnetic layer. The perpendicular magnetic recording head H1 shown in FIG. 1 is disposed on the reading section H_{R}. However, in another embodiment, the perpendicular magnetic recording head H1 may be disposed under the reading section H_{R}. In this case, the heat treatment temperature of the antiferromagnetic layer 50 and the fixed magnetic layer in a magnetic field is lower than the heat treatment temperature of the antiferromagnetic layer 50 and the second auxiliary magnetic layer 30 and the intensity of the magnetic field applied to the antiferromagnetic layer 50 and the fixed magnetic layer during heat treating is less than that of an exchange coupling magnetic field created between the antiferromagnetic layer 50 and the second auxiliary magnetic layer 30.

FIG. 9 shows a perpendicular magnetic recording head according to another embodiment of the present invention. This perpendicular magnetic recording head includes a second auxiliary magnetic layer 30 and an antiferromagnetic layer 50 lying over the lower face 30a of the second auxiliary magnetic layer 30. FIG. 12 shows a perpendicular magnetic recording head according to another embodiment of the present invention. This perpendicular magnetic recording head includes a first auxiliary magnetic layer 29, a second auxiliary magnetic layer 30 and antiferromagnetic layers 51. The antiferromagnetic layers 51 are spaced from each other in the track width direction (X direction) and each arranged on both side regions of the lower face 30a of the second auxiliary magnetic layer 30. The positions of the antiferromagnetic layers 51 are not limited to those shown in FIG. 12. Although the antiferromagnetic layers 51 are spaced from each other, exchange coupling magnetic fields are created between the second auxiliary magnetic layer 30 and the antiferromagnetic layers 51. Magnetization directions of inner regions of the second auxiliary magnetic layer 30 are along the track width direction (X direction) because of the magnetic interaction between the inner regions thereof, the inner regions being exposed from the antiferromagnetic layers 51. This allows the magnetic domains of the second auxiliary magnetic layer 30 and those of the first auxiliary magnetic layer 29 to be stabilized together with antiferromagnetic coupling between the first and second auxiliary magnetic layers 29 and 30.

FIG. 10 shows a perpendicular magnetic recording head according to another embodiment of the present invention. This perpendicular magnetic recording head, unlike the perpendicular magnetic recording head shown in FIG. 1, includes a main magnetic pole layer 60 having a small length in the height direction (Y direction). The main magnetic pole layer 60, unlike the main magnetic pole layer 20 shown in FIG. 3, has no rear section S3 but a front section S1 and a slope section S2 as shown in FIG. 11. This perpendicular magnetic recording head further includes an auxiliary magnetic section 24, which guides recording magnetic fields created from toroidal coils to the main magnetic pole layer 60. Therefore, the main magnetic pole layer 60, unlike the auxiliary magnetic section 24, need not extend to a region under which a lower coil piece 18 and upper coil piece 23 included in one of the toroidal coils that is most distant from the opposed face F are arranged in the thickness direction (Z direction). As shown in FIG. 11, the main magnetic pole layer 60 may extend to a portion of the auxiliary magnetic section 24. Although the main magnetic pole layer 60 is short in the height direction (Y direction), the magnetization of the main magnetic pole layer 60 can be directed in the track width direction (X direction) because the main magnetic pole layer 60 is ferromagnetically coupled with the auxiliary magnetic section 24 having magnetic domains which are magnetized in the track width direction (X direction) and which occupy much of the auxiliary magnetic section 24. The configuration of the main magnetic pole layer 60 is not limited to that shown in FIG. 11 and the main magnetic pole layer 60 may have only the front section S1 with a width equal to the track width Tw.

The first and second auxiliary magnetic layers 29 and 30 included in the auxiliary magnetic section 24 are made of a material with good soft magnetic properties, for example, a magnetic permeability greater than that of the main magnetic pole layer 20. The main magnetic pole layer 20 is made of a material with a saturation flux density greater than that of the first and second auxiliary magnetic layers 29 and 30. In particular, the main magnetic pole layer 20 is made of a Co—Fe—Ni alloy, a Co—Fe alloy, Co, or the like and the first and second auxiliary magnetic layers 29 and 30 are made of, for example, a Ni—Fe alloy. If the main magnetic pole layer 20 is made of another Ni—Fe alloy, the Fe content of this Ni—Fe alloy is greater than that of the Ni—Fe alloy for forming the first and second auxiliary magnetic layers 29 and 30. In particular, the Ni—Fe alloy for forming the first and second auxiliary magnetic layers 29 and 30 has an Fe content of 10% to 50% and the Ni—Fe alloy for forming the main magnetic pole layer 20 has an Fe content of 50% to 90% on a mass basis.

The perpendicular magnetic recording head H1 shown in FIG. 1 may include a spiral coil, disposed near the connecting section 27b, for generating a magnetic field instead of the toroidal coils.

In the perpendicular magnetic recording head H1 shown in FIG. 1, the return path layer 27 is disposed on the main magnetic pole layer 20; however, the main magnetic pole layer 20 may be disposed on the return path layer 27.

1. A perpendicular magnetic recording head comprising:
a first magnetic layer having a face opposed to a recording medium;
a second magnetic layer which has a face opposed to the recording medium and which is spaced from the first magnetic layer at a predetermined distance in a thickness direction, the opposed face of the second magnetic layer being longer than that of the first magnetic layer in a track width direction; and
a magnetic field generator for applying a recording magnetic field to the first and second magnetic layers,
wherein an auxiliary magnetic section including a plurality of auxiliary magnetic layers and non-magnetic layers each disposed between the auxiliary magnetic layers is disposed on at least one of an inside face of the first magnetic layer that is directed to the second magnetic layer or an outside face of the first magnetic layer that is opposite to the inside face, the auxiliary magnetic layers are arranged in the thickness direction, and one of the auxiliary magnetic layers that is most close to the first magnetic layer is directly bonded to the first magnetic layer.

2. The perpendicular magnetic recording head according to claim 1, wherein the auxiliary magnetic section has a front end face which is directed to the opposed faces and which is spaced back from the opposed faces in the direction toward a rear end face of the first magnetic layer.

3. The perpendicular magnetic recording head according to claim 1, further comprising an antiferromagnetic layer bonded to a face of the auxiliary magnetic section that is opposite to a joint face of the auxiliary magnetic section that is bonded to one of the non-magnetic layers that is most distant from the first magnetic layer.

4. The perpendicular magnetic recording head according to claim 1, wherein the first magnetic layer has side end faces directed in the track width direction, the auxiliary magnetic section has side end faces directed in the track width direction, and the side end faces of the first magnetic layer are located between those of the auxiliary magnetic section or are each flush with the corresponding side end faces of the auxiliary magnetic section in the thickness direction.

5. The perpendicular magnetic recording head according to claim 1, wherein a rear end face of the first magnetic layer is more close to the opposed faces than a rear end face of the auxiliary magnetic section or is flush with the rear end face of the auxiliary magnetic section in the thickness direction.
